(19) United States
(12) Patent Application Publication
(10) Pub. No.: US 2012/0131213 A1
(43) Pub. Date: May 24, 2012

(54) NETWORK DEVICE AND POINT TO POINT CONNECTION DISTINGUISHING METHOD

(75) Inventors: JIN JIANG, Shanghai (CN); CHI-HAN HUANG, Tu-Cheng (TW)

(73) Assignees: HON HAI PRECISION INDUSTRY CO., LTD., Tu-Cheng (TW); AMBIT MICROSYSTEMS (SHANGHAI) LTD., SHANGHAI (CN)

(21) Appl. No.: 13/040,280

(22) Filed: Mar. 4, 2011

(30) Foreign Application Priority Data
Nov. 23, 2010 (CN) 201010555529.1

(51) Int. Cl. G06F 15/16

(52) U.S. Cl. 709/228

(57) ABSTRACT

A network device connects a terminal device to the Internet using a plurality of connections. The network device obtains a quantity of different destination port numbers employed by the plurality of connections, calculates a ratio of the quantity of the different destination port numbers to a quantity of the connections, and determines that the connections include at least one point to point connection if the calculated ratio is larger than a predetermined ratio. The network device further determines that one of the connections is the point to point connection upon the condition that a communication protocol of the one of the connections is the transmission control protocol, that the destination port number of the one of the connections is larger than a predetermined port number, and that the average size of the packets of the one of the connections is larger than the predetermined size.

### BACKGROUND

1. Technical Field

Embodiments of the present disclosure relate to network devices, and more particularly to a point to point connection distinguishing method of a network device.

2. Description of Related Art

A terminal device, such as a computer, can access data from a large number of other terminal devices all over the Internet using the point to point data transmission technology. The terminal device usually employs a point to point application to download this large amount of data which is much more than data required by a browser in the terminal device. The point to point application requires a long time and occupies almost all the network bandwidth if the terminal device does not limit the network bandwidth of the point to point application. Then, the browser has no network bandwidth to browse websites when the point to point application is running. However, it may be important to keep browsing websites even when the point to point application is running. Therefore, it is important to control the network bandwidth of the point to point application.

Generally, a network device which allows the terminal device access to the Internet provides quality of service (QoS) for the terminal device to control the network bandwidth for the point to point application. The terminal device accesses data from the Internet by a plurality of connections, and the network device records the connections and provides QoS according to the connections. Therefore, how to distinguish point to point connections from the connections is very important for the network bandwidth control of the point to point application.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an operating environment and functional modules of one embodiment a network device of the present disclosure;

FIG. 2 is a bar graph of one ratio test result of the network device of FIG. 1; and

FIG. 3 is a flowchart of one embodiment of a point to point connection distinguishing method of the present disclosure.

### DETAILED DESCRIPTION

All of the processes described may be embodied in, and fully automated over, software code modules executed by one or more general purpose computers or processors. The code modules may be stored in any type of computer-readable medium or other storage device. Some or all of the methods may alternatively be embodied in specialized computer hardware or communication apparatus.

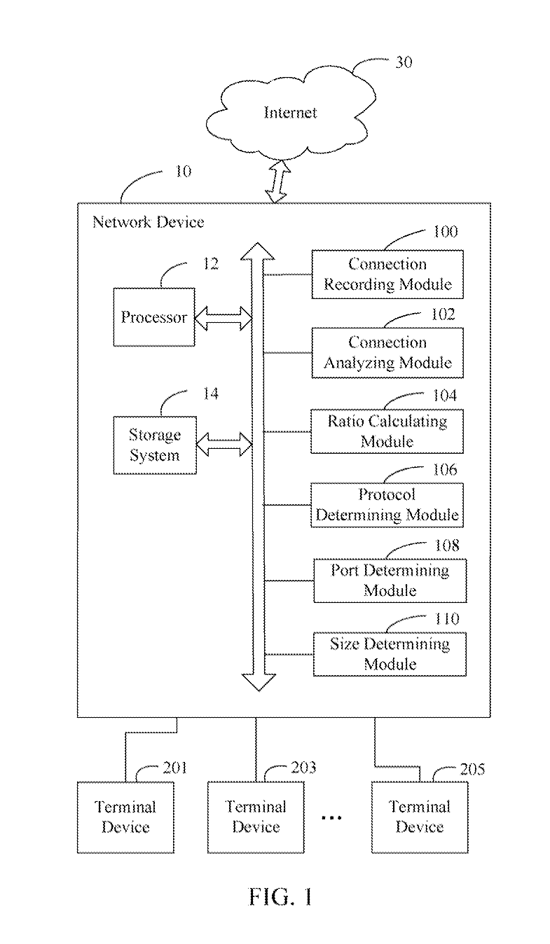

FIG. 1 is a schematic diagram of an operating environment and functional modules of one embodiment of a network device 10 of the present disclosure. In one embodiment, the network device 10 allows a plurality of terminal devices 201, 203, . . . , 205, access to the Internet 30. In one embodiment, the network device 10 may be a router, a gateway, a modem, and so on.

In one embodiment, the network device 10 includes a processor 12, a storage system 14, a connection recording module 100, a connection analyzing module 102, a ratio calculating module 104, a protocol determining module 106, a port determining module 108, and a size determining module 110. The connection recording module 100, the connection analyzing module 102, the ratio calculating module 104, the protocol determining module 106, the port determining module 108, and the size determining module 110 may comprise computerized codes in the form of one or more programs that are stored in the storage system 14. The computerized codes include instructions that are executed by the processor 12 to provide functions for those modules 100-110.

Point to point applications are installed in the terminal devices 201, 203, . . . , 205, therefore, the terminal devices 201, 203, . . . , 205 can access data from the Internet 30 by the point to point applications. Meanwhile, many other non point to point applications are installed in the terminal devices 201, 203, . . . , 205, such as a browser, a game application, an instant messaging application, and so on. The point to point applications and the non point to point applications establish connections to access data from or to the Internet 30.

Then, the connection recording module 100 records the connections and parameters of each of the connections from one of the terminal device 201. Each connection transmits a plurality of packets between the terminal device 201 and the Internet 30. The parameters of each of the connections comprise a source internet protocol address, a destination internet protocol address, a source port number, a destination port number, a communication protocol, the total quantity and the total byte of the packets transmitted by the corresponding connection.

The network device 10 corresponds each of the connections to the terminal devices 201, 203, . . . , 205 according to the source internet protocol address and the destination internet protocol address of the connections. In detail, if the source internet protocol address or the destination internet protocol address of one of the connections is the internet protocol address of the terminal device 201, then the one of the connections is corresponding to the terminal device 201.

The connection analyzing module 102 obtains a quantity of different destination port numbers employed by the plurality of connections of the terminal device 201. Some of the connections corresponding to the terminal device 201 may have a same destination port, and the others may have different destination ports. Therefore, the quantity of the different destination port numbers must be less than a quantity of the connections corresponding to the terminal device 201. For example, the connection recording module 100 records 500 connections corresponding to the terminal device 201, 300 of which having a same destination port number, such as 80, and 200 of which having an another same destination port number, such as 81. Then, the quantity of the different destination port numbers obtained by the connection analyzing module 102 is 2, that is 80 and 81.

The ratio calculating module 104 calculates a ratio of the quantity of the different destination port numbers to the quantity of the connections. For example, if the quantity of the different destination port numbers is 2 and the quantity of the connections is 500, then the ratio calculating module 104 calculates a ratio of 2 to 500 and obtains 0.4%. If the quantity of the different destination port numbers is 40 and the quantity of the connections is 500, then the ratio calculating module 104 calculates a ratio of 40 to 500 and obtains 8%.

The point to point application requires the terminal device 201 to access data from a number of other terminal devices in the Internet. On the contrary, the non point to point application, such as the web browser, commonly browses a website from a special data server in the Internet. Therefore, the ratio of the different destination port numbers to the quantity of the connections established by the point to point applications must be more than the ratio of the different destination port numbers to the quantity of the connections established by the non point to point applications. As such, the ratio calculating module 104 can determines that whether the connections include at least one point to point connection or not according to the calculated ratio.

Then, the ratio calculating module 104 determines if the calculated ratio is larger than a predetermined ratio. The predetermined ratio is an empirical value according to many tests of the ratio. Via the tests, the ratio of the quantity of the different destination port numbers to the quantity of the connections established by the point to point applications are generally more than 6%. On the contrary, the ratio of the quantity of the different destination port numbers to the quantity of the connections established by the non point to point applications are generally less than 2%. Therefore, the predetermined ratio can be set between 6% and 2%. In one embodiment, the predetermined ratio is 5.5%.

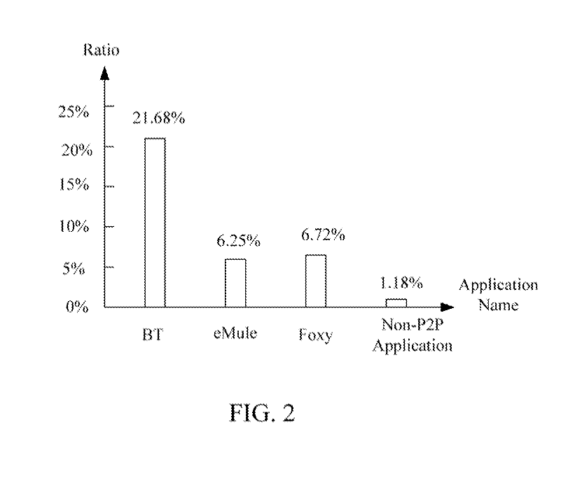

FIG. 2 shows result of one of the tests. In this test, three common point to point applications, namely BITTORRENT (BT), EMULE, PROXY, are selected. The ratios of the quantity of the different destination port numbers to the quantity of the connections established by BT, EMULE, and PROXY are respectively 21.68%, 6.25%, 6.72%. On the contrary, the ratio of the quantity of the different destination port numbers to the quantity of the connections established by the non point to point application is just 1.18%.

Therefore, the ratio calculating module 104 determines that the connections corresponding to the terminal device 201 comprise no point to point connection upon the condition that the calculated ratio is not larger than the predetermined ratio. On contrary, the ratio calculating module 104 determines that the connections corresponding to the terminal device 201 comprise at least one point to point connection if the calculated ratio is larger than the predetermined ratio.

The network device 10 in the present disclosure can determine that the connections corresponding to the terminal device 201 include no point to point connection just by determining the ratio. After the determination of the ratio, the network device 10 does not need other determinations if the connections corresponding to the terminal device 201 include no point to point connection, which improves distinguishing efficiency of the point to point connection.

Then, if the connections corresponding to the terminal device 201 comprise at least one point to point connection, the protocol determining module 106 determines if the communication protocols of the plurality of connections are the transmission control protocol (TCP). Because a point to point transmission always uses the transmission control protocol, not user datagram protocol or any other protocols, the protocol determining module 106 determines that the one of the connections is not the point to point connection if the communication protocol of the one of the connections is not the transmission control protocol.

Then, if the communication protocol of one of the connections is the transmission control protocol, the port determining module 108 determines if the destination port number of the one of the connections is larger than a predetermined port number. In one embodiment, the predetermined port number is preferably preset as 1024. Actually, all of the point to point applications cannot use ports whose number are less than 1024 because this kind of ports are defined by many kinds of network protocols, such as the transmission control protocol, and so on.

Then, the port determining module 108 determines that the one of the connections is not the point to point connection if the destination port number of the one connection is not larger than 1024.

Then, if the destination port number of the one of the connections is larger than the predetermined port number, the size determining module 108 determines if an average size of the packets of the one of the connections is larger than a predetermined size. In one embodiment, the average size is equal to the total byte of the packets divided by the total quantity of the packets of the one of the connections. The predetermined size is also an empirical value according to many tests of the packet size. In one embodiment, the predetermined size is 1200 byte.

Because most packets used by the point to point applications are much bigger than packets used by the non point to point applications, the size determining module 108 determines that the one of the connections is not the point to point connection if the average size of the packets of the one connection is not larger than the predetermined size.

Then, if the average size of the packets of the one of the connections is larger than the predetermined size, the size determining module 108 determines that the one of the connections is the point to point connection.

After the determination of the protocol determining module 106, the port determining module 108, and the size determining module 110, the network device 10 distinguishes the point to point connections from the connections corresponding to the terminal device 201. Then, the network device 10 can respectively provide different quality of services for the point to point connections and the non point to point connections, such as limiting network bandwidth used by the point to point connections, increasing priority of the non point to point connections, and so on.

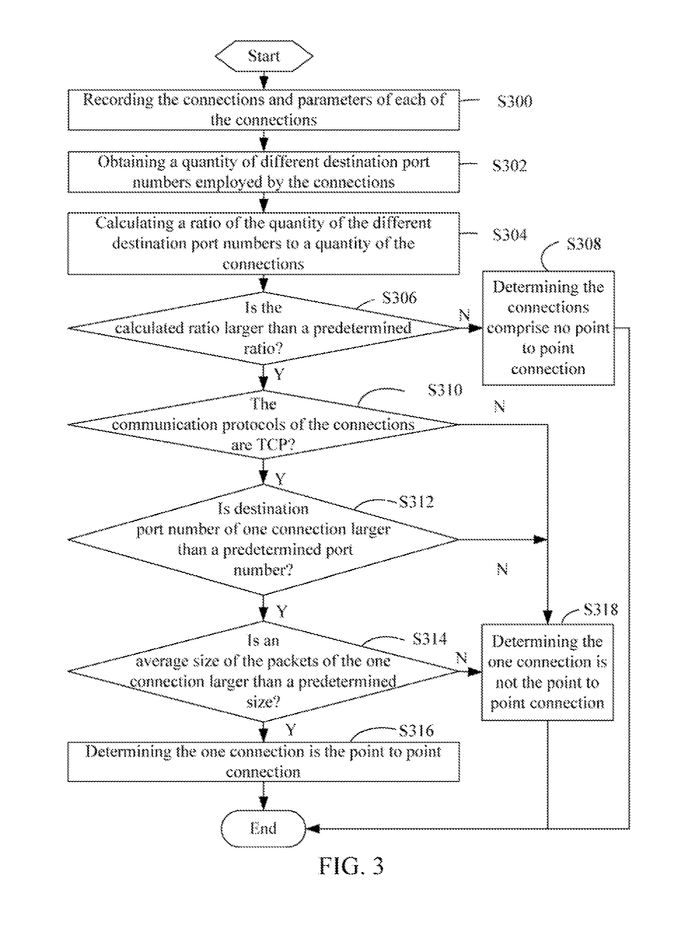

FIG. 3 is a flowchart of one embodiment of a point to point connection distinguishing method of the present disclosure. The flowchart is executed by the modules of the network device 10 of FIG. 1. Depending on the embodiment, additional blocks may be added, others deleted, and the ordering of blocks may be changed while remaining well within the scope of the disclosure.

In block S300, the connection recording module 100 records the connections and parameters of each of the connections from one of the terminal device 201. The parameters of each of the connections comprise a source internet protocol address, a destination internet protocol address, a source port number, a destination port number, a communication protocol, the total quantity and the total byte of the packets transmitted by the corresponding connection.

In block S302, the connection analyzing module 102 obtains the quantity of the different destination port numbers employed by the plurality of connections. In block S304, the ratio calculating module 104 calculates a ratio of the quantity of the different destination port numbers to the quantity of the connections. In block S306, the ratio calculating module 104 determines if the calculated ratio is larger than a predetermined ratio. If the calculated ratio is not larger than the predetermined ratio, then in block S308, the ratio calculating module 104 determines that the connections corresponding to the terminal device 201 comprise no point to point connection.

In one embodiment, the predetermined ratio is an empirical value according to many tests of the ratio. Via the tests, the ratio of the quantity of the different destination port numbers to the quantity of the connections established by the point to point applications are generally more than 6%. On the contrary, the ratio of the quantity of the different destination port numbers to the quantity of the connections established by the non point to point applications are generally less than 2%. Therefore, the predetermined ratio can be set between 6% and 2%. In one embodiment, the predetermined ratio is 5.5%.

If the calculated ratio is larger than the predetermined ratio, the ratio calculating module 104 determines that the connections corresponding to the terminal device 201 comprise at least one point to point connection. Then in block S310, the protocol determining module 106 determines if the communication protocols of the plurality of connections are the transmission control protocol (TCP).

If the communication protocol of one of the connections is not the transmission control protocol, then in block S318, the protocol determining module 106 determines that the one of the connections is not the point to point connection.

If the communication protocol of the one of the connections is the transmission control protocol, then in block S312, the port determining module 108 determines if the destination port number of the one of the connections is larger than a predetermined port number. In one embodiment, the predetermined port number is 1024. If the destination port number of the one connection is not larger than the predetermined port number, then in block S318, the port determining module 108 determines that the one of the connections is not the point to point connection.

If the destination port number of the one of the connections is larger than the predetermined port number, then in block S314, the size determining module 108 determines if an average size of the packets of the one of the connections is larger than a predetermined size. In one embodiment, the predetermined size is 1200 byte. If the average size of the packets of the one connection is not larger than the predetermined size, then in block S318, the size determining module 108 determines that the one of the connections is not the point to point connection.

If the average size of the packets of the one of the connections is larger than the predetermined size, then in block S316, the size determining module 108 determines that the one of the connections is the point to point connection.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A network device connecting a terminal device to the Internet using a plurality of connections each of which transmits a plurality of packets, the network device comprising:
a processor; and
a storage system storing computerized codes in the form of one or more programs operable to be executed by the processor, the one or more programs comprising:
a connection recording module configured for recording the connections and parameters of each of the connections, wherein the parameters of each of the connections comprise a source port number, a destination port number, a communication protocol, a total quantity and a total byte of the packets transmitted by the corresponding connection;
a connection analyzing module configured for obtaining a quantity of different destination port numbers employed by the plurality of connections;
a ratio calculating module configured for calculating a ratio of the quantity of the different destination port numbers to a quantity of the connections, for determining if the calculated ratio is larger than a predetermined ratio, and for determining that the connections comprise at least one point to point connection upon the condition that the calculated ratio is larger than the predetermined ratio;
a protocol determining module configured for determining if the communication protocols of the plurality of connections are the transmission control protocol;
a port determining module configured for, if the communication protocol of one of the connections is the transmission control protocol, further determining if the destination port number of the one of the connections is larger than a predetermined port number; and
a size determining module configured for, if the destination port number of the one of the connections is larger than the predetermined port number, determining if an average size of the packets transmitted over the one of the connections is larger than a predetermined size, and determining that the one of the connections is the point to point connection upon the condition that the average size of the packets transmitted over the one of the connections is larger than the predetermined size;
wherein the average size is equal to the total byte of the packets divided by the total quantity of the packets transmitted over the one of the connections.

2. The network device as claimed in claim 1, wherein the ratio calculating module is further configured for determining that the connections comprise no point to point connection upon the condition that the calculated ratio is not larger than the predetermined ratio.

3. The network device as claimed in claim 1, wherein the protocol determining module is further configured for determining that the one of the connections is not the point to point connection upon the condition that the communication protocol of the one of the connections is not the transmission control protocol.

4. The network device as claimed in claim 1, wherein the protocol determining module is further configured for determining that the one of the connections is not the point to point connection upon the condition that the destination port number of the one of the connections is not larger than the predetermined port number.

5. The network device as claimed in claim 1, wherein the size determining module is further configured for determining that the one of the connections is not the point to point connection upon the condition that the average size of the packets of the one of the connections is not larger than the predetermined size.

6. The network device as claimed in claim 1, wherein the predetermined ratio is 5.5%.

7. The network device as claimed in claim 1, wherein the predetermined port number is 1024.

8. The network device as claimed in claim 1, wherein the predetermined size is 1200 byte.

9. A point to point connection distinguishing method of a network device for connecting a terminal device to the Internet using a plurality of connections each of which transmits a plurality of packets, the method comprising:
recording the connections and parameters of each of the connections, wherein the parameters of each of the connections comprise a source port number, a destination port number, a communication protocol, a total quantity and a total byte of the packets transmitted by the corresponding connection;
obtaining a quantity of different destination port numbers employed by the plurality of connections;
calculating a ratio of the quantity of the different destination port numbers to a quantity of the plurality of connections;
determining if the calculated ratio is larger than a predetermined ratio;
determining that the connections comprise at least one point to point connection if the calculated ratio is larger than the predetermined ratio;
determining if the communication protocols of the plurality of connections are the transmission control protocol;
determining if the destination port number of one of the connections is larger than a predetermined port number if the communication protocol of the one of the connections is the transmission control protocol;
determining if an average size of the packets of the one of the connections is larger than a predetermined size if the destination port number of the one of the connections is larger than the predetermined port number, wherein the average size is equal to the total byte of the packets divided by the total quantity of the packets of the one of the connections; and
determining that the one of the connections is the point to point connection if the average size of the packets of the one of the connections is larger than the predetermined size.

10. The point to point connection distinguishing method as claimed in claim 9, further comprising the block of: determining that the connections comprise no point to point connection if the calculated ratio is not larger than the predetermined ratio.

11. The point to point connection distinguishing method as claimed in claim 9, further comprising the block of: determining that the one of the connections is not the point to point connection if the communication protocol of the one of the connections is not the transmission control protocol.

12. The point to point connection distinguishing method as claimed in claim 9, further comprising the block of: determining the one of the connections is not the point to point connection if the destination port number of the one of the connections is not larger than the predetermined port number.

13. The point to point connection distinguishing method as claimed in claim 9, further comprising the block of: determining that the one of the connections is not the point to point connection if the average size of the packets of the one of the connections is not larger than the predetermined size.

14. The point to point connection distinguishing method as claimed in claim 9, wherein the predetermined ratio is 5.5%.

15. The point to point connection distinguishing method as claimed in claim 9, wherein the predetermined port number is 1024.

16. The point to point connection distinguishing method as claimed in claim 9, wherein the predetermined size is 1200 byte.
